(19) United States
(12) Patent Application Publication
(10) Pub. No.: US 2002/0140148 A1
(43) Pub. Date: Oct. 3, 2002

(54) Holding means

(76) Inventors: Kurt Aigner, Klagenfurt (AT); Alfred Binder, Villach/Landskron (AT); Gerhard Kroupa, Villach (AT); Martin Matschitsch, Feistritz/Rosental (AT); Gerhard Pucher, Villach (AT); Werner Scherf, Frohnleiten (AT); Josef Unterweger, Annenheim Nr. (AT); Stefan Zerlauth, Klagenfurt (AT)

Correspondence Address: YOUNG & THOMPSON, 745 SOUTH 23RD STREET 2ND FLOOR, ARLINGTON, VA, 22202

(21) Appl. No.: 10/013,531

(22) Filed: Dec. 13, 2001

(30) Foreign Application Priority Data
Dec. 13, 2000 (DE) 10062011.6

(51) Int. Cl. B25B 1/00

(52) U.S. Cl. 269/21; 269/20

(57) ABSTRACT

For especially simple and reliable handling of thin and/or bent semiconductor wafers it is proposed in a corresponding holding means (100) that there is a gas flowing through at least one first means (5) for producing the forces which pull a semiconductor wafer toward the means (100) based on the Bernoulli principle and that there is at least one second means (2, 3) for holding the semiconductor wafer on the means (100) as a result of the forces produced by at least one electromagnetic field.

The invention relates to a holding means, especially a gripping means, a gripper, or the like, as claimed in the preamble of claim 1, with which wafer-shaped articles, especially wafers, thin wafers, or the like, as are used in semiconductor engineering, can be handled.

For holding and handling of wafers, holding means or grippers are known on which wafers are suctioned onto the gripper by negative pressure to which the vacuum openings in the surface of the gripper are exposed. In these grippers which work with negative pressure, the openings via which negative pressure takes effect can be varied almost at will in number, shape and distribution. One disadvantage of this known gripper is that the negative pressure for highly bent wafers cannot take effect to pull the wafer toward the gripper since at least in part an overly large distance is present between the openings to which the negative pressure is applied, and the wafer itself.

Grippers for wafers have also been proposed in which the wafer is held on the gripper by a pressurized gas flowing out of at least one nozzle due to the forces produced as a result of the Bernoulli principle. In these grippers, at least at one site in the gripper, in the surface of which facing the wafer a pressurized gas, for example, air or nitrogen, emerges. The flow which has been produced in this way between the wafer and gripper according to the Bernoulli principle allows a force to develop which pulls the wafer toward the gripper. It is inherently advantageous in these grippers that the force which forms according to the Bernoulli principle also pulls even highly bent wafers toward the gripper, therefore the wafer can be at least largely aligned flat or planarized. Conversely, in these Bernoulli grippers it is a disadvantage that the holding of wafers according to the Bernoulli principle is problematic in spaces with reduced pressure, for example, vacuum chambers or the like.

For chucks on which wafers are held while they are being worked or treated, it is also known that the wafer can be fixed on the chuck by electrostatic forces. The electrostatic forces in the wafer causes charge separation and the wafer is pulled toward the chuck. When the wafers are held on the chucks using the electrostatic principle it is disadvantageous that high electrical voltages up to +/−3 kV are necessary in order to be able to hold the wafer. In any case, the Coulomb forces which occur are very weak because the forces decrease with the square of the distance between the wafers and grippers. Many forces are generally not sufficient to pull highly bent wafers toward the gripper surface.

Since wafers today are becoming thinner and thinner, at wafer sizes of 5.6 and 8 inches to 50 microns, conventional grippers can no longer be used. Thin wafers are not only extraordinarily subject to fracture, but often also have warping of up to 16 mm out of the wafer plane, and moreover under certain circumstances are highly distorted.

To be able to reliably handle bent wafers, for example in the loading and unloading of trays, quartz boats, etc. it is necessary to stabilize the wafer flat on a gripper.

The object of the invention is to devise a holding means for handling wafer-shaped articles, especially for semiconductor wafers, thin wafers or the like, with which especially thin and bent wafers can be reliably and safely handled.

This object is achieved with a holding means as claimed in the invention by the characterizing features of claim 1. Preferred and advantageous embodiments are the subject matter of the independent subclaims.

The concepts of holding means, gripper means, and grippers are used synonymously to one another below. Likewise a wafer or semiconductor wafer is always also defined as a thin wafer.

In the holding means as claimed in the invention, to hold the wafer both the Bernoulli principle and also the electromagnetic principle are used. In doing so under certain circumstances bent and distorted wafers are planarized or aligned flat first of all by forces produced based on the Bernoulli principle, pulled toward the holding means or toward the gripper and then held on the gripper by electromagnetic, especially electrostatic forces.

In the gripper as claimed in the invention, on the one hand means for holding using the Bernoulli principle and on the other hand means for holding by electromagnetic, especially electrostatic forces, are implemented. To hold a wafer once it has been placed on the gripper, the feed of the gas which produces the forces which planarize the wafer as a result of the Bernoulli principle is turned off and only electrostatic forces are maintained. In this way, with the gripper as claimed in the invention wafers can be held and handled also in spaces with reduced gas or air pressure. In a vacuum the Bernoulli principle does not work, but it can be compensated by the electromagnetic forces.

In practice, when a holding means as claimed in the invention is being used for planarization and stabilization of the wafer by the forces which form as a result of the Bernoulli principle, first of all a pressurized gas, for example air or nitrogen, is routed with several times atmospheric pressure through a channel to at least one nozzle which discharges on the gripper surface. The nozzle through which the pressurized gas emerges can be made circular and/or can be interrupted in segments, and can have a radius in the range from 20 to 25% of the gripper diameter. The outflow opening for the pressurized gas which causes the holding force according to the Bernoulli principle can be aligned either obliquely, for example at an acute angle, for example 20°, or essentially parallel to the gripper surface. In the gripper as claimed in the invention, in place of a circular nozzle and/or a nozzle interrupted in segments there can also be several individual nozzles which are supplied with a pressurized gas. These individual nozzles preferably have alignments which are pointed obliquely to the plane of the gripper, its being preferred that the alignment of the nozzles is chosen such that the pressurized gas emerges from the individual nozzles in a flow direction which is placed obliquely to the axis of the gripper and which is pointed towards the edge of the gripper.

The electrostatic field is implemented with at least two electrodes which are triggered bipolarly opposite, a dielectric being located over the electrode surfaces. It is preferable if the area ratio between the positively and negatively charged electrode or electrodes is roughly one.

In one preferred embodiment the base body of the gripper with channels for flow of the pressurized gas is produced from a nonmetallic material. The base body however can also be made of other than a nonmetallic material.

The components of the gripper which hold a wafer by electrostatic forces on the gripper can be produced by different processes and are integrated into the gripper, for example by thick film hybrid technology with special ceramics as dielectrics or using coated foils.

The execution of the gripper as claimed in the invention makes it possible to match its geometrical dimensions to its intended application.

The gripper as claimed in the invention can be made thin, the thickness of the gripper being dictated by the channels which are necessary for holding using the Bernoulli principle because the electrostatic components can be kept very flat, for example, a few 100 microns.

In one embodiment of the gripper as claimed in the invention the exit opening for the pressurized gas for the Bernoulli principle is aligned obliquely to the gripper surface so that the electrodes for holding the wafer using the electrostatic principle can be worked into the gripper and the entire gripper surface is flat.

In another embodiment the electrodes can be arranged concentrically to one another, and there can be a nozzle for the emergence of the pressurized gas between the electrodes.

It is also possible to arrange two semicircular electrodes within the nozzle for the emergence of the pressurized gas.

In one embodiment in which the gas for the Bernoulli principle flows out of the nozzle tangentially to the gripper surface, in the surface of the gripper facing the wafer a step of a few 100 microns is formed which makes it possible to incorporate the electrodes for electrostatics in the uppermost plane. This embodiment has the advantage that the wafer is pressed by the force which arises as a result of the Bernoulli principle against the electrodes and lies on them.

In special cases, an embodiment of the gripper as claimed in the invention can be used in which in addition to the means for holding the wafer using the Bernoulli principle and the electrostatic principle in the surface of the gripper facing the wafer there is an opening exposed to negative pressure, for example, in the “vacuum head” or the like.

In one embodiment of the gripper as claimed in the invention in which there is at least one opening exposed to negative pressure, it is possible to make the negatively pressurized openings as vacuum heads which can be moved perpendicular to the plane of the gripper. This embodiment has the advantage that the vacuum heads, when they are not exposed to negative pressure, project over the gripper surface so that the negative pressure for holding the wafer can reliably take effect. As soon as the vacuum heads are exposed to negative pressure, they move into the gripper until their upper end surface on which the wafer is held by negative pressure, at least essentially, is located in the plane of the gripper surface facing the wafer. Thus, reliable and flat holding of the wafer is ensured.

When using the gripper as claimed in the invention, the functions for holding a wafer, specifically holding by electrostatic forces, can be triggered by the forces which arise as a result of the Bernoulli principle and, if provided, by negative pressure, individually or in any combinations and thus can be effective for holding the wafer.

The required feeds—especially for pressurized gas, a possible vacuum and electrostatics—and their connections can be implemented in different ways. These feeds can for example be implemented in the handle of the gripper by channel systems for compressed gas and a vacuum and lines for the electrical potential. Moreover, in this respect there can also be the corresponding measures for use of the gripper as claimed in the invention in spaces in which reduced pressure prevails.

Other details, features, and advantages of the invention derive from the follow description of preferred embodiments of the holding means as claimed in the invention using the drawings.

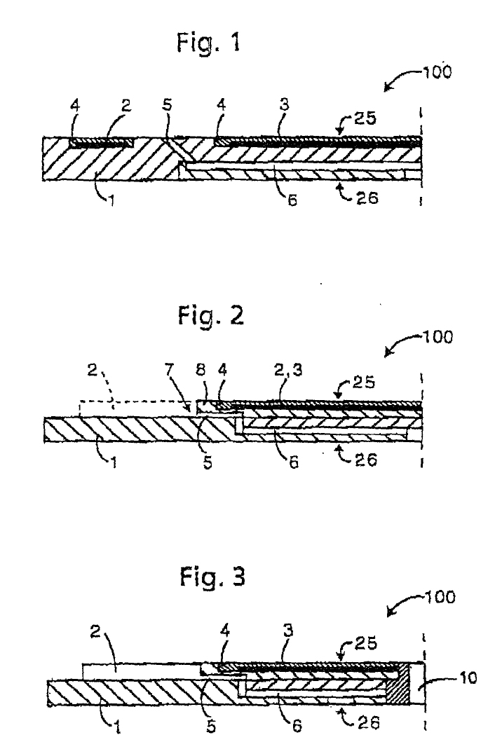

FIG. 1 shows schematically in a section a first embodiment of the holding means as claimed in the invention.

FIG. 2 shows schematically in a section a second embodiment of the holding means as claimed in the invention.

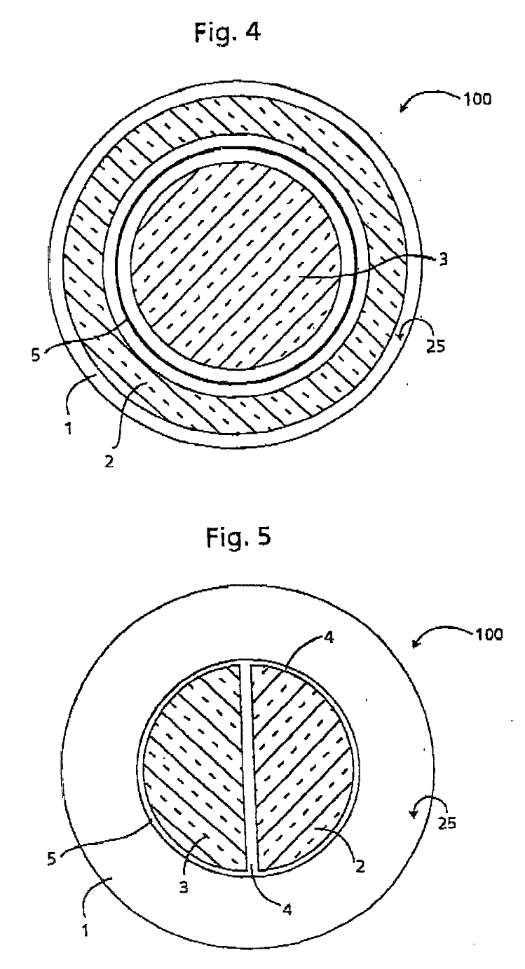

FIG. 3 shows schematically in a section a third embodiment of the holding means as claimed in the invention.

FIG. 4 shows o ne embodiment of the holding means as claimed in the invention with the electrodes arranged in a circular ring.

FIG. 5 shows one embodiment of the holding means as claimed in the invention with the electrodes in the center of the holding means.

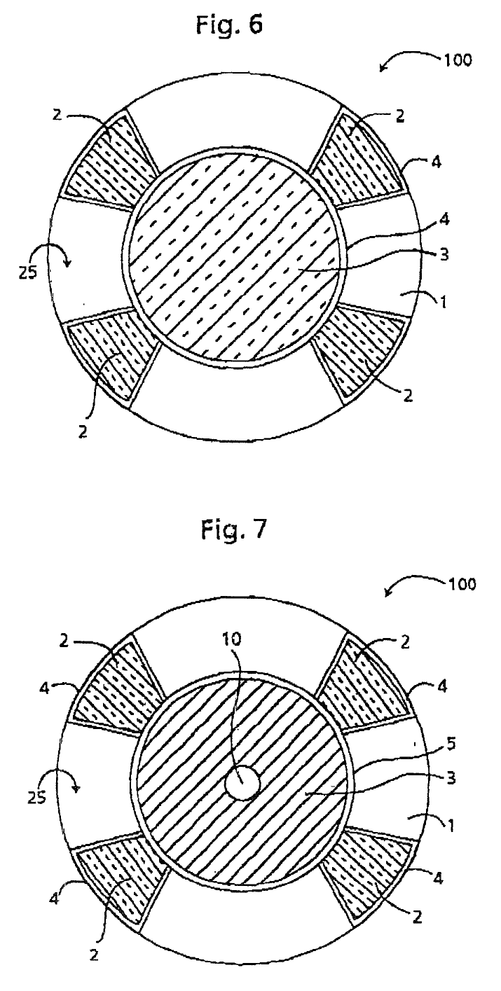

FIG. 6 shows one embodiment of the holding means as claimed in the invention with segmented electrodes and one middle electrode.

FIG. 7 shows one embodiment of the holding means as claimed in the invention with an opening which can be exposed to negative pressure.

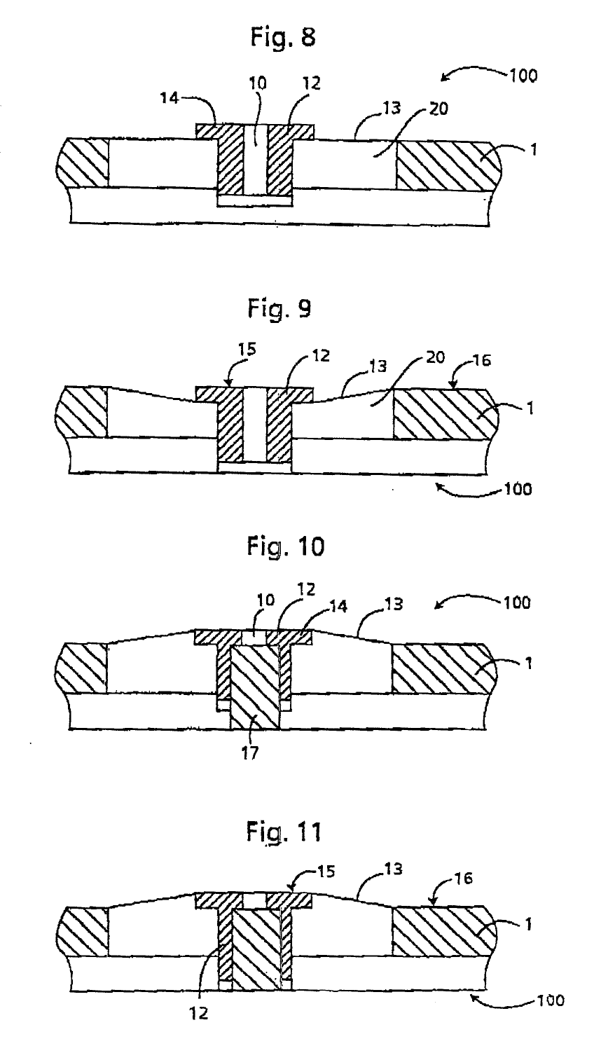

FIG. 8 shows partially in a section one detail of the holding means as claimed in the invention with a vacuum head which can be moved perpendicular to the gripper surface without exposure to negative pressure.

FIG. 9 shows the detail of the embodiment from FIG. 8 with a vacuum head exposed to negative pressure.

FIG. 10 shows another embodiment of a vacuum head which can be moved perpendicular to the gripper surface without exposure to negative pressure.

FIG. 11 shows the vacuum head of the embodiment from FIG. 10 with exposure to negative pressure.

In the embodiment of a gripper 100 as claimed in the invention shown in FIG. 1 in a section and in FIG. 4 in a top view, there are an annular electrode 2 and a round disk-shaped electrode 3 in a base body 1 in the form of a circular wafer in depressions on the top 25, therefore the side 25 of the base body 1 facing the wafer to be held. The electrodes 2 and 3 are embedded in the dielectric 4 which also covers the surfaces of the electrodes 2 and 3 which point up.

In the base body 1 there is a circular nozzle 5 which discharges at an acute angle to the surface 25 of the base body 1 facing the wafer. The nozzle 5 is exposed to pressurized gas, for example air or preferably nitrogen, via a channel 6 which is provided in the base body.

The electrodes 2 and 3 are dimensioned such that the area ratio between the electrode 2 and 3 is roughly one.

The electrodes 2 and 3 are triggered bipolarly opposite so that an electrostatic field forms which attracts a wafer which has been placed on the gripper 100 (not shown) so that it rests on the surface 25 of the gripper which lies at the top in FIG. 1.

In order to move the wafer very close to the gripper 100, specifically to the surface 25 which lies at the top in FIG. 1, at least at the start of placement of a wafer on the gripper 100 the nozzle 5 is supplied with a pressurized gas via the channel 6 so that forces which pull the wafer toward the gripper 100 are produced as a result of the Bernoulli principle by the gas discharging between the base plate 1 and the wafer and emerging from the nozzle 5. These forces which are produced as a result of the Bernoulli principle by the discharging gas are relatively large in order to pull the wafer reliably against the upper surface 25 of the gripper 100 when the wafer is bent, i.e. bent wafers are planarized or aligned flat at the same time. As soon as the wafer has been pulled against the gripper 100, the feed of pressurized gas to the nozzle 5 can be interrupted, and the wafer is held securely against the surface 25 of the gripper 100 facing it solely as a result of the electrostatic forces which are produced by the electrodes 2 and 3.

In the embodiment shown in FIG. 2, the side 25 of the base body 1 facing the wafer is made stepped by there being a circular elevation 8 in the middle of the base body 1. The nozzle 5 which is supplied with pressurized gas via the channel 6 discharges in the area of the step 7 which has been formed in this way. As FIG. 2 shows, the outflow direction of the pressurized gas from the nozzle 5 in the embodiment shown in FIG. 2 is essentially parallel to the surface extension of the base body 1.

In a depression in the elevation 8 of the base body 1—this part can be formed by a separate component—there are two electrodes 2 and 3 which are made hemispherical. The electrodes 2 and 3 are covered to the top by a dielectric in the embodiment of a gripper 100 as claimed in the invention which is shown in FIG. 2 and are insulated from one another by the dielectric 4 (see FIG. 5).

The embodiment of a gripper 100 as claimed in the invention which is shown in FIGS. 2 and 5 can be altered as shown in FIG. 6 and as is indicated by the broken line in FIG. 2. In this altered embodiment there is a single electrode 3 in the depression in the projecting elevation 8 of the base body 1. Outside of the circular electrode 3 and outside the step 7 there are electrodes 2 with the shape of a segment of a circular ring. These electrodes 2 are likewise covered to the top by a dielectric 4.

FIGS. 3 and 7 show an embodiment which has been modified compared to the embodiment from FIG. 6, in which in the middle of the gripper 100 there is an opening 10 which can be exposed to negative pressure in order to produce an additional holding force for a wafer fixed on the gripper 100. One such opening 10 which is exposed to negative pressure can also be implemented for all other embodiments shown.

It should be pointed out that the shape and arrangement of the electrodes 2 and 3 of the gripper as claimed in the invention can be modified in any way. The alignment and type as well as the size of the nozzle 5 by which pressurized gas for producing the forces which pull the wafer toward the gripper 100 as a result of the Bernoulli principle are not important [sic]. Thus, in addition to the circular or circular arc-shaped nozzles, there can also be nozzles in the form of holes which are located for example along one circle in the base body 1 of the gripper 100.

In all the illustrated embodiments of the gripper 100 as claimed in the invention, instead of an annular nozzle 5 for producing a force which pulls a wafer toward the gripper 100 as a result of the Bernoulli principle, there can also be a plurality of nozzles 5. These nozzles 5 can be circular arc-shaped nozzles 5 or nozzles 5 which are made as holes. When the nozzles 5 which are provided with pressurized gas for producing a holding force using the Bernoulli principle are made as holes, they are preferably located on a circle which is concentric to the center of the gripper 100 and are preferably aligned such that they are aligned obliquely to the surfaces 25 of the gripper 100 which face the wafer. Here an alignment of the nozzles 5 is preferred in which the axes of the nozzles 5 point obliquely to the outside, as is shown for the annular nozzle 5 in the cross section from FIG. 1.

When there are several nozzles 5 made as holes, they can, as mentioned, be located along a circle which is arranged as is shown in FIGS. 4 to 7 for a circular nozzle 5. In this embodiment the holes are distributed over the periphery of the circle on which the circular ring-shaped nozzle 5 discharges.

One embodiment of a gripper 100 as claimed in the invention is also possible in which the nozzles 5 supplied with pressurized gas are located within the electrodes 2 and/or 3. For example, oblique holes made as nozzles 5 for producing a holding force as a result of the Bernoulli principle can also be routed obliquely also through the middle electrode 3, in which case there is insulation in the form of a dielectric 4 in these channels.

When the gripper 100 as claimed in the invention is made with a means for holding a wafer using negative pressure, the negative pressure can be applied through a middle opening 10, as is described using FIGS. 3 and 7.

Here it is possible to make the vacuum head which is exposed to negative pressure in order to hold a wafer adjustable and optionally tiltable in the direction perpendicular to the plane of the gripper 100. Embodiments as can be made in practice—the opening 10 exposed to negative pressure can be movable—are shown in FIGS. 8 to 11.

In the embodiment shown in FIGS. 8 and 9, there is a vacuum head 12, specifically a vacuum pin, which has an opening 10 which is exposed to negative pressure in the center. The vacuum head 12 sits with an edge flange 14 from the top on a flexible foil 13 which covers the top of the base body 1 of the gripper 100. If the vacuum head 12 is exposed to negative pressure, it moves into the position shown in FIG. 9 in which its end surface 15 which points to the outside lies in plane 16 which is defined by the surface 25 of the gripper 100 facing the wafer.

In the embodiment shown in FIGS. 10 and 11, the vacuum head 12 with its edge flange 14 is attached from underneath resting against the flexible foil 13. In addition, in the embodiment shown in FIGS. 10 and 11, there is a compression spring 17 which presses the vacuum head 12 into the position which projects over the gripper 100 and which is shown in FIG. 10. In the embodiment shown in FIGS. 10 and 11 the vacuum head 12 moves perpendicularly to the plane of the gripper 100 when it is exposed to negative pressure and ultimately assumes the position shown in FIG. 11, in which its end surface 15 is flush with the surface 16 of the gripper 100.

When the gripper 100 as claimed in the invention is additionally equipped with openings which can be exposed to negative pressure, as for example the vacuum heads 12 of FIGS. 8 to 11, feed of pressurized gas and/or exposure to negative pressure—then only electrostatic forces work—can be ended as soon as the wafer has been placed against the gripper 100. Then the vacuum heads 12 remain in the lowered position shown for example in FIGS. 9 and 11, when there is the embodiment of a gripper 100 which as shown in FIG. 1 has a continuous flat surface on the side 25 of the gripper 100 facing the wafer. In a stepped embodiment (FIGS. 2 and 3) of a gripper the vacuum heads 12, when they have been exposed to negative pressure, are lowered into the gripper 100 only so far that their upper end surface 15 lies in the plane which is defined by the upper end surface of the projection 8.

In the embodiment with vacuum heads 12, there can be several such vacuum heads 12 with largely any arrangement on the gripper. The vacuum heads 12 are for example mounted on a flexible foil 13 and in the base body 1 of the gripper 100 there is one vacuum chamber 20 underneath each vacuum head 12. When the vacuum heads 12 are not exposed to negative pressure, the upper end surfaces 15 of the vacuum heads 12 project out of the gripper surface 25, a projection of a few tenths of a millimeter being possible.

In the embodiments shown in FIGS. 8 and 9, the vacuum head 12 is inserted into an opening of the flexible foil 13. In the embodiment shown in FIGS. 10 and 11 the vacuum head 12 with its upper end surface adjoins the flexible foil 13 from underneath, in the area of the opening 10 of the vacuum head 12 exposed to negative pressure there being an opening in the flexible foil 13.

Exposing the vacuum heads 12 to negative pressure is implemented for example by a system of channels in the base body 1 of the gripper 100.

The embodiments shown in the drawings are only preferable embodiments of the invention. It is important that there are both means, for example exit openings or nozzles for pressurized gas for producing forces using the Bernoulli principle, and at the same time means, for example electrodes which are triggered bipolarly and oppositely, in order to hold a wafer on the gripper by Coulomb forces of attraction which are produced by electrostatic fields.

The segmented electrodes of FIGS. 6 and 7 are preferably interconnected, i.e. charged with rectified potential, this potential however being opposite the potential with which the circular electrode 3 which is located in the middle is charged.

1. Holding means, especially a gripping means, a gripper, or the like, for holding wafer-shaped articles, especially wafers, thin wafers, or the like,
characterized in that
there is at least one first means (5) for producing the forces which pull the wafer-shaped article toward the holding means (100) based on the Bernoulli principle by a flowing gas and
that there is at least one second means (2, 3) for holding the wafer-shaped article on the holding means (100) as a result of the forces produced by at least one electromagnetic field.

2. Holding means as claimed in claim 1, wherein the second means (2, 3) is made for producing at least one electrostatic field and/or for producing Coulomb forces.

3. Holding means as claimed in one of the preceding claims, wherein the first means (5) is or has a nozzle (5) which discharges in the surface (25) facing the wafer-shaped article and which can be supplied with a pressurized gas in operation.

4. Holding means as claimed in claim 3, wherein the nozzle (5) discharges at an acute angle to the surface (25) of the holding means (100) facing the wafer-shaped article in this surface (25).

5. Holding means as claimed in claim 3, wherein the nozzle (5) discharges essentially parallel to the surface (25) of the holding means (100) facing the wafer-shaped article.

6. Holding means as claimed in claim 5, wherein the nozzle (5) discharges in the area of a step (7) in the surface (25) of the holding means (100) facing the wafer-shaped article.

7. Holding means as claimed in one of claims 3 to 6, wherein the nozzle (5) is made in the shape of a circular ring or circular arc and/or wherein there are several nozzle holes which discharge in the area of a circle which is concentric to the center of the holding means (100).

8. Holding means as claimed in one of the preceding claims, wherein the second means (2, 3) is made essentially as an electrode (2, 3) or has one.

9. Holding means as claimed in one of the preceding claims, wherein in the holding means (100) there is a second means (2, 3), especially electrodes (2, 3), in the surface facing the wafer-shaped article, their surface (25) facing the wafer-shaped articles being covered by a dielectric (4), and wherein the electrodes (2, 3) are made to be bipolarly triggerable for forming the electromagnetic or electrostatic field in operation.

10. Holding means as claimed in claim 9, wherein the area ratio between at least one positively and at least one negatively charged electrode (2, 3) is roughly one (1).

11. Holding means as claimed in claim 9 or 10, wherein in the center of the holding means (100) there is one circular electrode (3) and outside of it there is one circular electrode (2).

12. Holding means as claimed in claim 11, wherein the nozzle (5) is located between the electrodes (2, 3).

13. Holding means as claimed in claim 9 or 10, wherein there are two semicircular electrodes (2, 3).

14. Holding means as claimed in claim 13, wherein the nozzle (5) is located outside the electrodes (2, 3).

15. Holding means as claimed in claim 9 or 10, wherein there are a circular electrode (3) and at least two other electrodes (2) radially outside of it.

16. Holding means as claimed in claim 15, wherein the electrodes (2) which are located outside the circular electrode (3) which is located in the center are made in the shape of the segment of a circular ring.

17. Holding means as claimed in claim 15 or 16, wherein the nozzle (5) is located around the center electrode (3) and radially within the electrodes (2) which are located outside.

18. Holding means as claimed in one of claims 9 to 17, wherein the electrodes (2, 3) are isolated from one another by at least one dielectric (4).

19. Holding means as claimed in one of the preceding claims, wherein in the surface (25) of the holding means (100) facing the wafer-shaped article there is at least one opening (10) which can be exposed to negative pressure.

20. Holding means as claimed in claim 19, wherein there is an opening (10) which can be exposed to negative pressure in the vacuum head (12) and wherein the vacuum head (12) can be moved perpendicular to the plane of the holding means (100) and optionally can be tilted/inclined.

21. Holding means as claimed in claim 20, wherein without exposing the vacuum head (12) to negative pressure the outer end surface (15) of the vacuum head (12) projects over the surface (25) of the holding means (100) facing the wafer-shaped article.

22. Holding means as claimed in claim 10 or 21, wherein the vacuum head (12) is held by a flexible foil (13).

23. Holding means as claimed in claim 22, wherein the vacuum head with the edge flange (14) sits from the outside on the flexible foil (13).

24. Holding means as claimed in claim 22, wherein the vacuum head (12) adjoins the flexible foil (13) from the inside.

25. Holding means as claimed in one of claims 22 to 24, wherein the vacuum head (12) is attached to the foil (13).

26. Holding means as claimed in one of claims 20 to 25, wherein in the area of the vacuum head (12) in the base body (1) of the holding means (100) a chamber (20) is recessed which can be exposed to negative pressure.

27. Holding means as claimed in one of claims 20 to 26, wherein a compression spring (17) is assigned to the vacuum head (12) and loads it into its position projecting with its end surface (15) over the surface (16) of the holding means (100).
